(19) United States
(12) Patent Application Publication
(10) Pub. No.: US 2009/0172163 A1
(43) Pub. Date: Jul. 2, 2009

(54) SYSTEMS AND METHODS OF ON-DEMAND WAKING OF COMPUTERS

(75) Inventors: Ted A. Carroll, Seattle, WA (US); Bruce Twito, Lake Forest Park, WA (US)

Correspondence Address: WILSON SONSINI GOODRICH & ROSATI, 650 PAGE MILL ROAD, PALO ALTO, CA, 94304-1050, US

(73) Assignee: Verdiem Corporation

(21) Appl. No.: 12/021,256

(22) Filed: Jan. 28, 2008

Related U.S. Application Data
(60) Provisional application No. 61/018,424, filed on Dec. 31, 2007.

(51) Int. Cl. G06F 15/173; G06F 1/26; G06F 1/32

(52) U.S. Cl. 709/226; 713/323

(57) ABSTRACT

The invention is directed to systems and methods of on-demand waking of computers from a reduced power state, whether they are on standby, hibernating, or off. The invention may use multiple redundant proxies capable of receiving commands and waking computers within a broadcast domain to wake computers that may not be able to directly broadcast to one another as part of a Wake on WAN (WOW) system. Accordingly, the invention may monitor proxies and computers and determine whether a computer is part of a broadcast domain. The WOW system may select new proxies as needed or desired according to a method of selecting preferred proxies.

### CROSS-REFERENCE

This application claims the benefit of U.S. Provisional Application No. 61/018,424 filed Dec. 31, 2007, which application is incorporated herein by reference.

### FIELD OF THE INVENTION

The invention relates to systems and methods of on-demand waking of computers from a reduced power state, whether they are on standby, hibernating, or off. The invention uses multiple redundant proxies capable of receiving commands and waking computers within a broadcast domain to wake computers that may not be able to directly broadcast to one another. Accordingly, the invention may select new proxies as needed and may have a method of selecting preferred proxies.

### BACKGROUND OF THE INVENTION

Large organizations may often have computers on more than one network segment, where a network segment includes computers with the same IP network number, and each network segment can have multiple computers connected across their own local network such as a Local Area Network (LAN). These machines may be coordinated from a central or controlling location, across a larger network such as a Wide Area Network (WAN). As part of systems management, software updates, patches, and other data may have to be delivered to the multiple computers at different network segments across the larger network. However, users of different computers may shut down computers, or some organizations may implement a power savings management system that can result in putting computers into a reduced power state. In order to implement computer maintenance, IT managers must ideally be able to remotely wake networked computers from reduced power states, such as standby, hibernate or off, on-demand.

The use of a networked computer to wake up another computer from a reduced power state has been in existence. For instance, Wake on LAN (WOL) is a standard Ethernet technology that allows networked computers to be turned on by using only special network signals. When correctly configured for WOL, a computer's Ethernet interface may listen for a special pattern of data on the network, which may be called a magic packet. When the computer's Ethernet interface sees the magic packet with its own unique address, it causes the PC to awaken from a reduced power state such as standby, hibernate, or off.

The WOL magic packet is an Ethernet packet that specifies either a broadcast address or target Media Access Control (MAC) address as the destination. A common way of formulating such a packet is to use a broadcast special User Datagram Protocol (UDP) broadcast packet. Since the operating system must be able to translate between the target IP address and the MAC address using an Address Resolution Protocol (ARP), which is only reliable when the target machine is on, the standard practice is to simply use the broadcast address for the destination address.

Since the magic packet is, in standard practice, an Ethernet broadcast, it can only reach computers that can be reached by broadcast network traffic. In large networks, routers are used to manage network congestion with different network numbers used on each network connected to the router. Usually in a routed network, broadcasts can only reach devices with the same broadcast domain. This usually implies that devices with the same network number are on the same broadcast domain. Since in large organizations, there are often many network segments joined together by a router, another method of waking computers across different network segments must be found.

Other solutions have been attempted to wake a computer on another network segment. For example, one may configure routers between different networks to forward broadcasts among network segments. However, in most cases this practice is ill-advised since it can lead to problems such as broadcast storms, where a chain reaction may occur, culminating in a state where new network connections cannot be established, and existing connections may be dropped. A broadcast storm is a network condition in which so many broadcasts are occurring that normal communication between hosts are disrupted.

Another example is using a static proxy to wake up other computers within a given network segment. A network segment may have a client serving as a proxy, which may be configured to receive a command from another computer to send magic packets to other computers within the same network segment. This may prevent problems such as broadcast storms, but relies on the proxy functioning; if a proxy were to fail, such as by shutting down, human presence may be required on-site to set up a new proxy or restart the existing one.

There is a need for improved systems and methods for effective on-demand waking of computers from a reduced power state. A further need exists for solutions that do not present risks of network problems such as broadcast storms, and which does not require on-site presence.

### SUMMARY OF THE INVENTION

The invention provides systems and methods for on-demand waling of computers. Various aspects of the invention described herein may be applied to any of the particular applications set forth below or for any other types of computer power control or broadcast systems or methods. The invention may be applied as a standalone system or method, or as part of an integrated arrangement relating to networked computer management. It shall be understood that different aspects of the invention can be appreciated individually, collectively, or in combination with each other.

The invention may include a Wake on WAN (WOW) system which may use multiple redundant proxies capable of receiving commands and waking computers within a broadcast domain. Accordingly, the invention may select new proxies as needed or desired.

An aspect of the invention provides a WOW system which may wake computers on a Wide Area Network (WAN), such as a corporate network, even though some of the computers on the WAN cannot directly broadcast to each other. The WOW system may use multiple redundant proxies in a broadcast domain. The proxies may be selected from any of the computers within the broadcast domain. The selected proxies may be capable of receiving a command from a server in communication with the broadcast domain to send a wake-up packet to at least one other computer in the broadcast domain. The command to the proxy may originate from different sources, such as from an individual or automatically as part of computer systems management.

A broadcast domain may be the portion of computers on a network where the computers can send broadcast network traffic to each other. A broadcast domain may be a network segment if computers within the network segment can broadcast to one another and not outside of the network segment. Networks may employ routers, which may prevent computers from broadcasting across network segment boundaries.

The wake-up packet sent by a proxy may be a User Datagram Protocol (UDP) broadcast, which may cause a computer to awaken from a reduced power state such as standby, hibernate, or off. The wake-up packet can be used in different ways to wake up computers. For example, the wake-up packet may be broadcast across the entire broadcast domain, which may be required if the Address Resolution Protocol (ARP) will fail. In another example, the wake-up packet may be directed to a specific computer in a broadcast domain, which may not be a general solution since routers generally do not pass raw Ethernet packets. In some cases, the wake-up packet may be directed to a subset of computers in a broadcast domain.

In one embodiment of the invention, the server may automatically choose the proxies. When a proxy is chosen, the WOW system may prevent the proxies from entering a reduced power state, such as shutting down or going into standby or hibernate. For instance, if the system were to implement an energy saving mode that put unused computers into a reduced power state, the system may exclude the proxies to keep them awake. However, in some cases, a proxy may enter a reduced power state when explicitly commanded to do so by a user at the console, or by a network administrator.

By having multiple proxies, the WOW system may be able to provide a redundancy that may ensure that proxies are available for given broadcast domains. A server may detect and monitor whether a minimum number of proxies are available. If a server were to detect that it has lost connectivity to a proxy, it may automatically select another computer within the same broadcast domain to assume the role. By having multiple proxies, the WOW system may ensure that even if a proxy were to fail, at least one other proxy may be available to send a wake-up packet to a computer in the broadcast domain, if it is necessary to wake a computer to assume the role of a proxy.

In one aspect of the invention, a server may select another computer to assume the role of a failed proxy by following a proxy selection procedure. A server may select a new proxy by using any sort of selection process, whether it be randomly, or by following a step by step procedure. In one embodiment of the invention, the administrators of the WOW system may be able to optionally indicate which computers within a broadcast domain may be preferred proxies. For example, a server may select a computer to assume the role of a proxy by following an order of preference such that: (1) a computer is a preferred proxy and is connected and awake, (2) a computer is a preferred proxy and is in a reduced power state, (3) a computer is not a preferred proxy and is connected and awake, and (4) a computer is not a preferred proxy and is in a reduced power state. If the selected computer is in a reduced power state, an existing proxy may awaken it by sending it a wake-up packet. Then the computer may assume the role of a proxy and be capable of receiving commands from the server to send wake-up packets to other computers within the broadcast domain.

In alternate embodiment of the invention, a server may select a computer to assume the role of a proxy based on a preference order such that: (1) a computer has some sort of direct remote power control capability, (2) a computer does not have a direct remote power control capability but is connected and awake, and (3) a computer does not have a direct remote power control capability and is in a reduced power state. If the selected computer is in a reduced power state, an existing proxy may awaken it by sending it a wake-up packet.

A preferable embodiment of the invention may incorporate both preference orders and select a computer to become a proxy based on a preference order such that: (1) a computer is a preferred proxy, (2) a computer has a direct remote power control capability, (3) a computer is connected and awake, and (4) a computer is in a reduced power state.

Another aspect of the invention may determine an order of preference for a client computer to serve as a proxy when connected or connecting to a broadcast domain. The system may determine where the newly connected client falls in the preference order for proxies, if one exists. If the client is a more highly preferred proxy than an existing proxy, the WOW system may replace a less desirable proxy with the client. In that manner, the WOW system may eventually have the most preferred available clients serving as proxies.

If all of the existing proxies were to fail simultaneously, the server may still be able to select a computer to assume the role of a proxy. The server may monitor a broadcast domain where all of the proxies have failed and may determine whether any computers are connected and awake. If any computers in a broadcast domain are awake, the server may select one or more of the computers to be a proxy. The newly selected proxies may be capable of waking other computers in the broadcast domain as needed. As long as at least one computer is awake on the network, the WOW system may be able to choose a proxy, and to select and wake other proxies as needed.

If all of the existing proxies and all of the other computers within a broadcast domain were to fail simultaneously, the server may monitor the broadcast domain to determine whether any computers wake up. If a computer were to wake up, the server may select the computer to be a proxy, and may be able to select and wake other proxies as needed.

One aspect of the invention may enable the WOW system to determine which computers are in the same broadcast domain. In one embodiment of the invention, the server may examine the IP numbers of the computers. The server may determine that computers with the same IP network numbers can broadcast to each other, and are therefore in the same broadcast domain. This may be true in most corporate networks.

In an alternate embodiment of the invention, the server may use the computers to discover whether computers can broadcast to one another and thus are in the same broadcast domain. The server may instruct computers to listen for broadcasts, such as UDP broadcasts, on a special port, (i.e. port 5601). The server may then discover which computers can broadcast to one another. Computers that can reach each other may be in the same broadcast domain.

If a computer is in a standby mode, more than one mechanism may be used to awaken the computer. In addition to receiving a wake-up packet, a computer on standby may awake when any IP packet is directly to it (i.e. a directed packet), when a power button is manually pressed, when a mouse is manually moved, when a key on the keyboard is manually pressed, or other triggers, such as receiving a fax. The WOW system may be able to incorporate any of these methods in order to awaken a computer from standby mode.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The features and advantages of the invention may be further explained by reference to the following detailed description and accompanying drawings that sets forth illustrative embodiments.

FIG. 1 shows a WOW system and proxy selection.

FIG. 2 is an illustration of a system with proxies in broadcast domains.

FIG. 3 illustrates multiple broadcast domains and how redundant proxy selection operates.

FIG. 4 is a flow chart showing a process for monitoring all proxies.

FIG. 5 is a flow chart showing a process for monitoring broadcast domain proxies.

FIG. 6 is a flow chart showing proxy election.

FIG. 7A is a flow chart showing a proxy election round.

FIG. 7B is a continuation of a flow chart showing a proxy election round.

FIG. 8 is a flow chart showing a select client process.

FIG. 9 is a flow chart showing an on connect process that may be called whenever a client connects.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

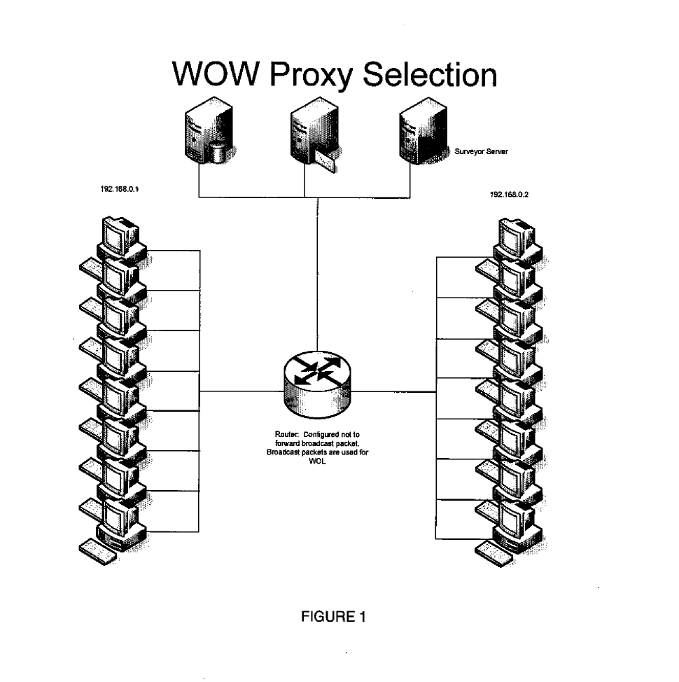

Referring to the drawings in detail, FIG. 1 shows a Wake on WAN (WOW) system and proxy selection. The WOW system may include one or more server, one or more router, and one or more broadcast domains consisting of multiple computers. The servers may be connected to several broadcast domains via a sequence of one or more routers. Multiple computers may be connected to a broadcast domain.

Within each of the broadcast domains, at least two computers may be set up to act as multiple redundant proxies. Any of the computers within a broadcast domain may function as a proxy, although there may preferences in the proxy election process (proxy election is described in detail below). Commands may be delivered from the servers to the proxies within the broadcast domains. The commands to proxies may arise in a number of different ways. For example, the commands may originate from an individual, such as a system administrator, or may originate automatically as part of a computer system management, such as a periodic software maintenance. The proxies, in response to the commands, may send wake-up packets to one or more computers within the broadcast domain.

The wake-up packet may be a User Datagram Protocol (UDP) broadcast, which may cause a computer to awaken from a reduced power state such as standby, hibernate, or off. The wake-up packet can be used to wake one or more computers in different ways. For example, the wake-up packet may be broadcast across the entire broadcast domain, which may be required if the Address Resolution Protocol (ARP) will fail. In another example, the wake-up packet may be directed to a specific computer in a broadcast domain, which may not be a general solution since routers generally do not pass raw Ethernet packets. In another instance, the wake-up packet may be directed to wake a subset of computers in a broadcast domain.

When a wake-up packet or magic packet is sent to a computer that is shut down, there may still be power reserved for the computer's network interface card. The network interface card, which may be a low-level mechanism without any processing power, may listen for the wake-up packet. The circuitry on the network interface card may be listening for a power transition from on or off. The listening computer may receive the wake-up packet, check it for the correct information, and awake if the packet is valid.

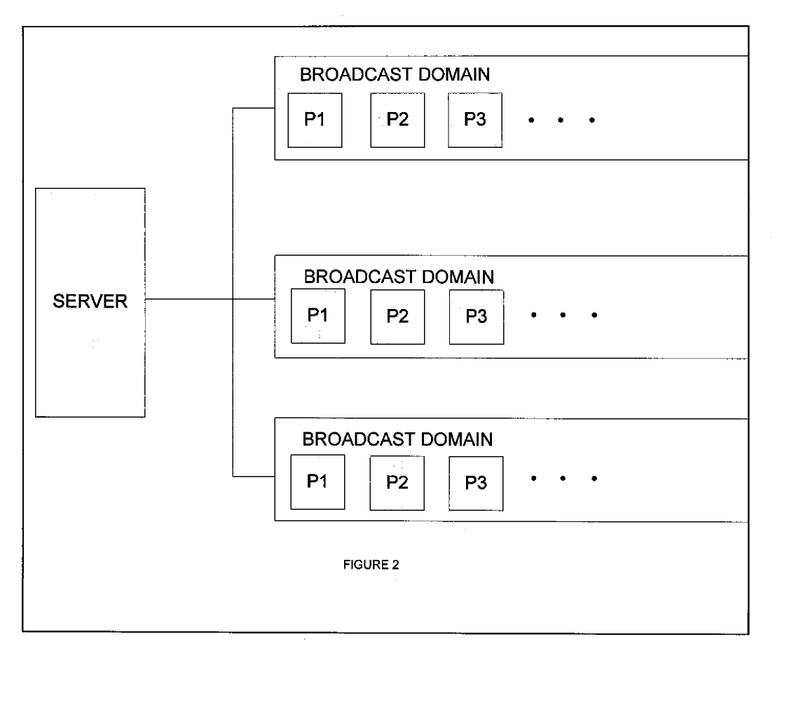

FIG. 2 is an illustration of a system with proxies in accordance with a preferable embodiment of the invention. A server may be communicating with one or more broadcast domain, each of which may have multiple redundant proxies.

A broadcast domain may be the portion of computers on a network that can send broadcast network traffic to each other. A broadcast domain may be a network segment if computers within the network segment can broadcast to one another and not outside of the network segment. Networks may use routers which may prevent computers from broadcasting across network segment boundaries.

The WOW system may be able to determine which computers are in the same broadcast domain. In one embodiment of the invention, the server may examine the IP numbers of the computers. If the administrator determines that computers with the same IP network numbers can broadcast to each other, and are therefore in the same broadcast domain, then the server can avoid potentially expensive processing by using this assumption. This may be true in most corporate networks.

In an alternate embodiment of the invention, the server may use the computers to discover whether computers can broadcast to one another and thus are in the same broadcast domain. The server may instruct computers to listen for broadcasts, such as UDP broadcasts, on a special port, (i.e. port 5601). The server may then discover which computers can broadcast to one another. Computers that can reach each other may be considered to be in the same broadcast domain.

Each broadcast domain may have multiple redundant proxies. The WOW system or server may monitor the proxies and prevent them from entering a reduced power state, such as shutting down or going into standby or hibernate. For instance, if the system were to implement an energy saving mode that put unused computers into a reduced power state, the system may exclude the proxies to keep them awake. However, in some cases, a proxy may enter a reduced power state when explicitly commanded to do so by a network administrator or a user explicitly shutting the computer down, pressing the power button, unplugging the computer, or if the proxy computer experiences a failure. By monitoring the broadcast domain proxies, the WOW system may know when a proxy may fail. In addition, the server may know when a client computer may come online. The WOW system may be aware of which clients are awake and which clients are selected as proxies.

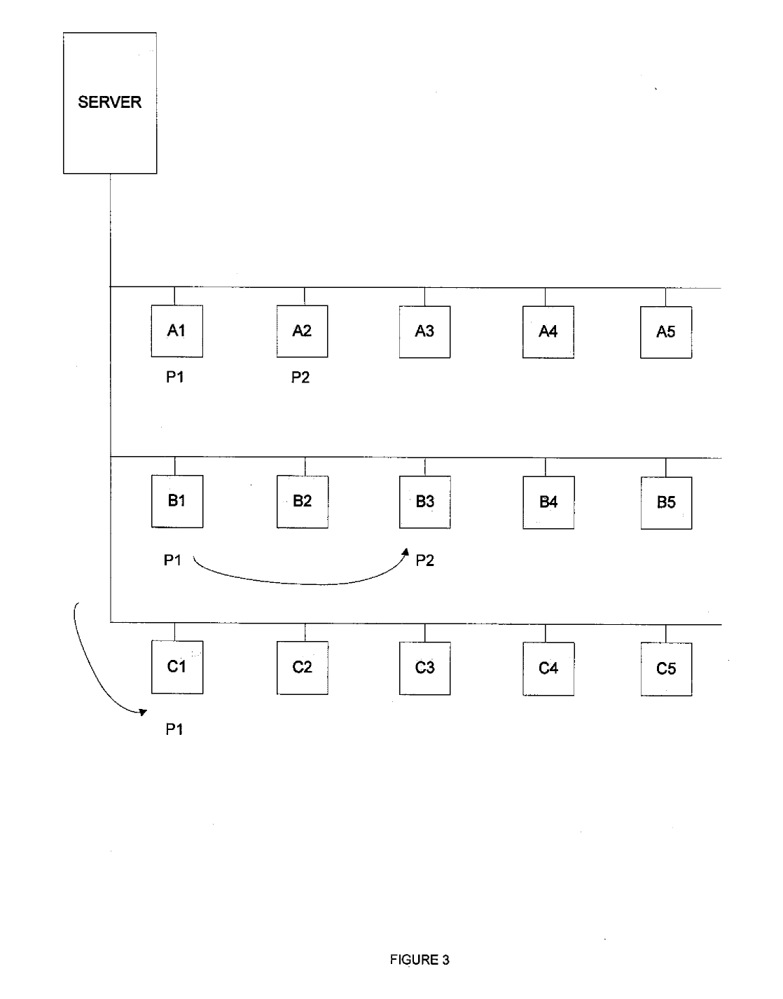

FIG. 3 illustrates multiple broadcast domains and proxy selection. In one embodiment of the invention, the server may automatically choose the proxies. When a proxy is chosen, the WOW system may prevent the proxies from entering a reduced power state, such as shutting down or going into standby or hibernate. For example, in the first broadcast domain, A1 and A2 may be the initial proxies, denoted by P1 and P2, and may be maintained in a high power state. However, in some cases, a proxy may enter a reduced power state when explicitly commanded to do so by a network administrator or a user explicitly shutting the computer down, pressing the power button, unplugging the computer, or if the proxy computer experiences a failure. The system may monitor to determine whether any of the proxies enter a reduced power state.

By having multiple proxies, the WOW system may be able to provide a redundancy that may ensure that proxies are available for given broadcast domains. A server may detect and monitor whether the proxies are available. If a server detects that it has lost connectivity to a proxy, it may automatically select another computer within the same broadcast domain to assume the role. For example, in the second broadcast segment, B1 and B2 may originally have been proxies. However, if the system detects that B2 has lost connectivity, the system may select an alternate proxy, such as B3. By having multiple proxies, the WOW system may ensure that even if a proxy were to fail, at least one other proxy may be available to send a wake-up packet to a computer in the broadcast domain, if it is necessary to wake a computer to assume the role of a proxy. If B3 had originally been asleep, B1 may have been capable of waking B3 and then making it the second proxy. Additionally, if B1 were to subsequently fail, the WOW system may be able to choose a new proxy and use B3 to wake it if necessary.

If all of the existing proxies were to fail simultaneously, the server may still be able to select a computer to assume the role of a proxy. The server may monitor a broadcast domain where all of the proxies have failed and may determine whether any computers are connected and awake. If any computers in a broadcast domain are awake, the server may select one or more of the computers to be a proxy. For example, in the third broad domain shown, if the previous proxies all failed, but the WOW system sees that C1 is awake, the server may choose C1 to be a proxy. The server may choose other computers in the broadcast segment to be proxies and C1 can wake them if necessary. The newly selected proxies may be capable of waking other computers in the broadcast domain as needed. As long as at least one computer is awake on the network, the WOW system may be able to choose a proxy, and to select and wake other proxies as needed.

Even if all of the existing proxies and all of the other computers within a broadcast domain were to fail simultaneously (and no other computers were awake), the server may monitor the broadcast domain to determine whether any computers wake up. If a computer were to wake up, the server may select the computer to be a proxy, and may be able to select and wake other proxies as needed. For example, in the third broadcast segment illustrated, if all of the computers had been offline, but then C1 woke up, then the system may detect that C1 was connected and may make C1 a proxy. From that point on, the system could determine other proxies as necessary and use C1 to wake any other computers and make them proxies.

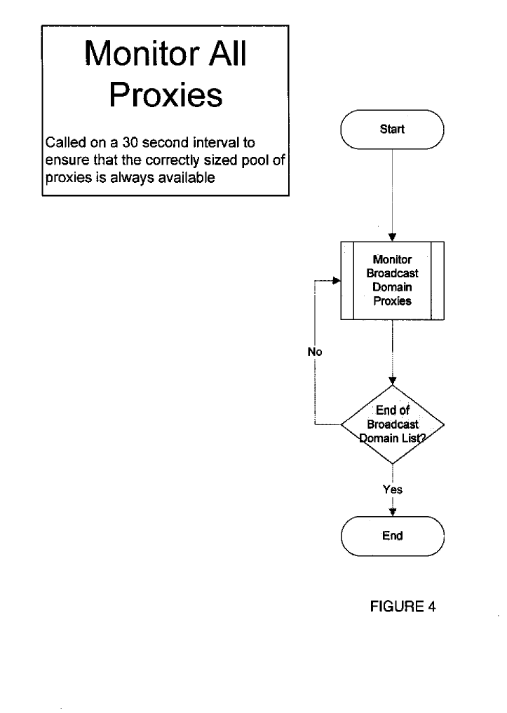

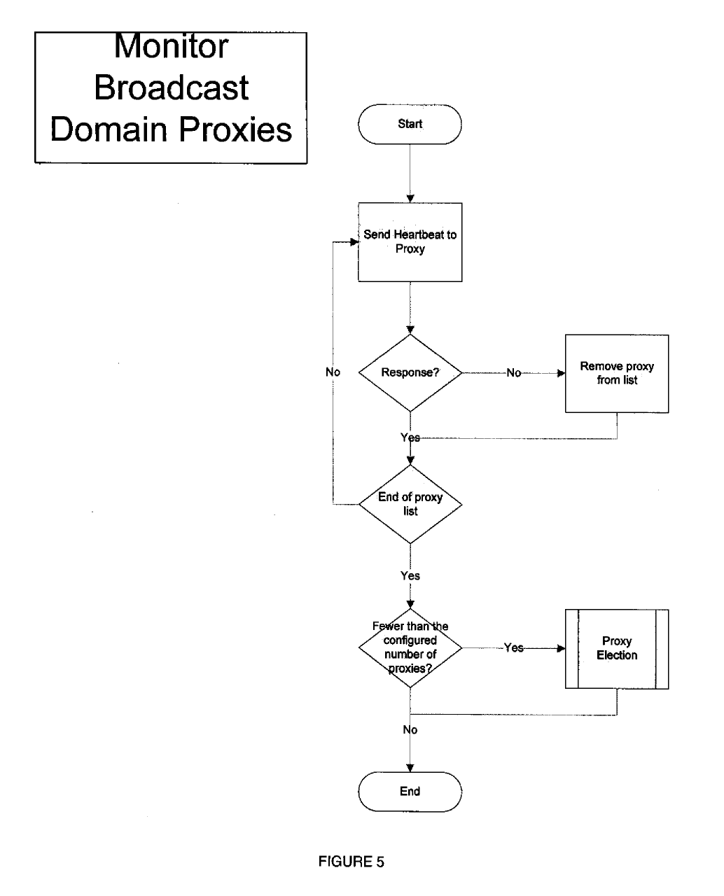

FIG. 4 is a flow chart showing a process for monitoring all proxies. A WOW system may monitor proxies within a broadcast domain to determine whether any have failed and need to be replaced. In a preferable embodiment of the invention, the WOW system may monitor broadcast domain proxies (procedure to be described in FIG. 5). The system may monitor broadcast domain proxies until it reaches the end of the broadcast domain proxy list. The process for monitoring all proxies may occur at a time increment in order to ensure that the correctly sized pool of proxies is available. For example, the process for monitoring all proxies may be called every 30 seconds. Time increments may be fixed or may vary depending on the situation or time. The more frequently the process for monitoring all proxies may occur, the more quickly a server may determine whether a proxy has failed and a replacement proxy can be elected.

FIG. 5 is a flow chart showing a process for monitoring broadcast domain proxies. A WOW system or server may send a heartbeat to a proxy in order to determine whether the proxy is connected and operational. If the proxy fails to send a response, it may be determined to have failed and may be removed from the current proxy list. If the proxy does send a response, it may be determined to be operational. The system may repeat this step for all of the proxies in the proxy list, until it is determined to have reached the end of the proxy list. In this manner, the server may determine whether any of the proxies on the proxy list have failed.

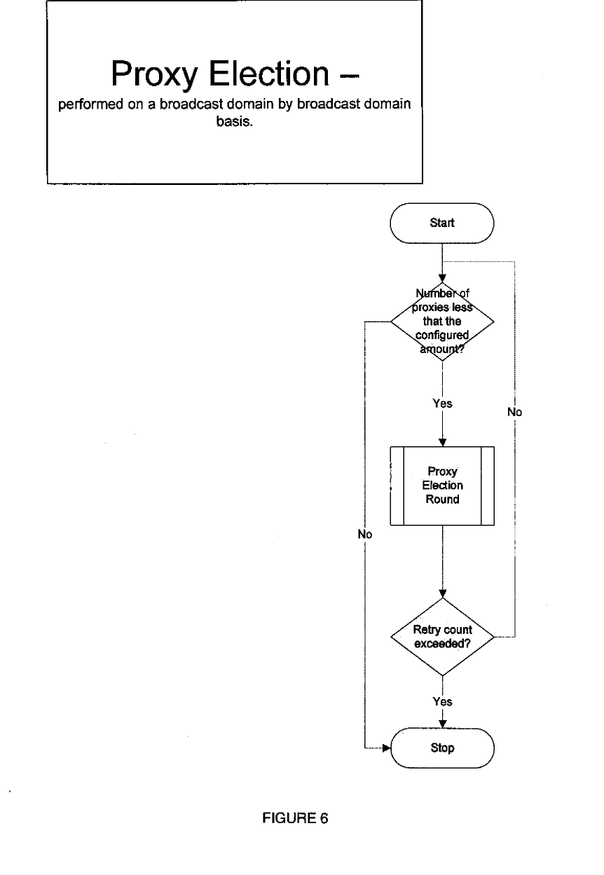

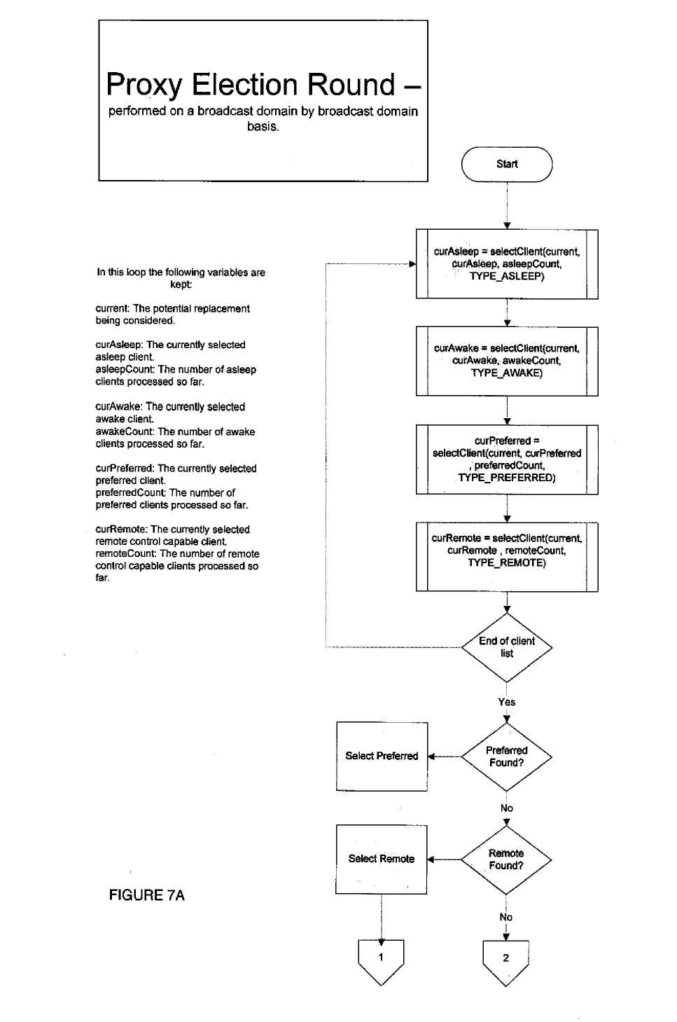

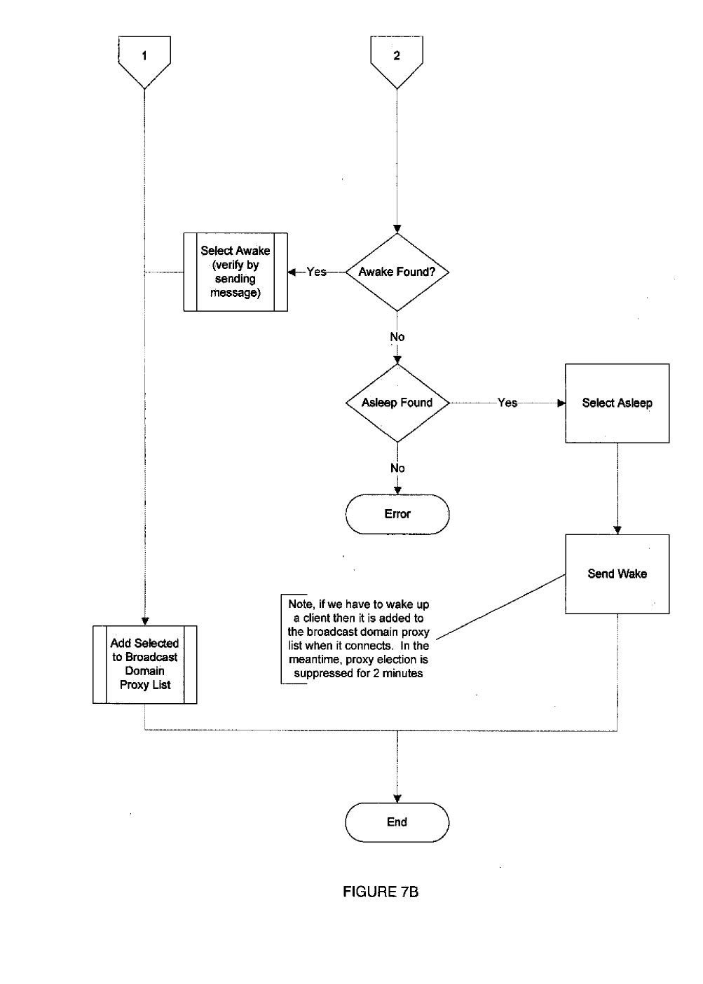

The system may then determine whether fewer than the configured number of proxies are operational. The configured number of proxies may be the original number of proxies that were originally determined, or may represent a minimum number of proxies in the system. If fewer proxies are operational, then the system may implement a proxy election process (procedure to be described in FIGS. 6, 7A, 7B). Proxy election may occur when one or more proxies may have failed, and may occur to replace the failed proxy and maintain the minimum number of proxies.

In one aspect of the invention, proxy election may occur when a server may select another computer to assume the role of a failed proxy. In one embodiment of the invention, a server may select a new proxy randomly. Alternatively, a server may select a new proxy using any sort of selection process, such as by following a step by step procedure. For instance, the administrators of the WOW system may be able to optionally indicate which computers within a broadcast domain are preferred proxies. A server may select a computer to assume the role of a proxy by following an order of preference such that: (1) a computer is a preferred proxy and is connected and awake, (2) a computer is a preferred proxy and is in a reduced power state, (3) a computer is not a preferred proxy and is connected and awake, and (4) a computer is not a preferred proxy and is in a reduced power state. If the selected computer is in a reduced power state, an existing proxy may awaken it by sending it a wake-up packet. Then the computer may assume the role of a proxy and be capable of receiving commands from the server to send wake-up packets to other computers within the broadcast domain.

In another example, a server may select a computer to assume the role of a proxy based on a preference order such that: (1) a computer has some sort of direct remote power control capability, such as Intel's Active Management Technology, (2) a computer does not have a direct remote power control capability but is connected and awake, and (3) a computer does not have a direct remote power control capability and is in a reduced power state. If the selected computer is in a reduced power state, the computer may not awaken immediately, but instead the direct remote power control facility may be used to wake it if, and only if, the proxy is required to send a wake-up packet on the system's behalf.

A preferable embodiment of the invention may incorporate both preference orders and select a computer to become a proxy based on a preference order such that: (1) a computer is a preferred proxy, (2) a computer has direct remote power control capability, (3) a computer is connected and awake, and (4) a computer is in a reduced power state.

Illustrating a preferable implementation of proxy election, FIG. 6 is a flow chart showing a proxy election procedure. The system may determine whether fewer than the configured number of proxies are operational. If the minimum number of proxies is met, the system may end the proxy election procedure. If fewer proxies are operational, then the system may implement a proxy election round (procedure to be described in FIG. 7A, 7B), which may elect a proxy. After implementing the proxy election round, the system may determine whether a retry count may have been exceeded. If the retry count was not exceeded, then the system may repeat the previous steps of determining whether the number of operational proxies are fewer than the number of proxies that were configured, and implementing the proxy election round if necessary. The system may repeat these steps until the retry count is exceeded or the minimum number of proxies is met. If the retry count is exceeded or if the number of operational proxies is not fewer than then configured amount, then the proxy election process may end.

FIG. 7A is a flow chart illustrating an exemplary proxy election round. A WOW system may select a proxy by following a preference order. The proxy election round may occur on a broadcast domain by broadcast domain basis. In one implementation of the proxy election round, the system may select a random client of each type by looking at a current client, which may be a potential replacement for the currently selected client. The replacement may be selected if a random number between 0 and 1 is less than 1 divided by the number of clients of that type which have been examined. Therefore, at the end of the selection process one client of each type may have been randomly selected. At this point the priority mechanism may take over to determine which type of client is the ultimate winner of proxy election.

The system may then select a computer to assume the role of the proxy following a preference order. The system may determine whether a preferred client was found. If a preferred client was found, the system may select the currently selected preferred client to be the proxy. If a preferred client was not found, the system may determine whether a remote control capable client was found. If a remote control capable client was found, the system may select the currently selected remote control capable client to be the proxy. FIG. 7B illustrates a continuation of the proxy election round. If a remote control capable client was not found, the system may determine whether an awake client was found. If an awake client was found, the system may select the currently selected awake client to be the proxy. If an awake client was not found, the system may determine whether an asleep client was found. If an asleep client was found, the system may select the asleep client to be the proxy. If an asleep client was not found, then an error may occur, which implies that proxy election may be re-executed then next time proxy monitoring executes.

If a preferred client, a remote control capable client, or an awake client is selected to be a proxy, then the newly selected proxy may be added to a broadcast domain proxy list. If an asleep client is selected to be a proxy, then the asleep proxy may be awakened. If there is an existing proxy, it may send a wake-up packet to the asleep proxy. If a client has to be awakened, it may be added to the broadcast domain proxy list when it connects. In the meantime, proxy elections may be suppressed for a length of time, such as two minutes.

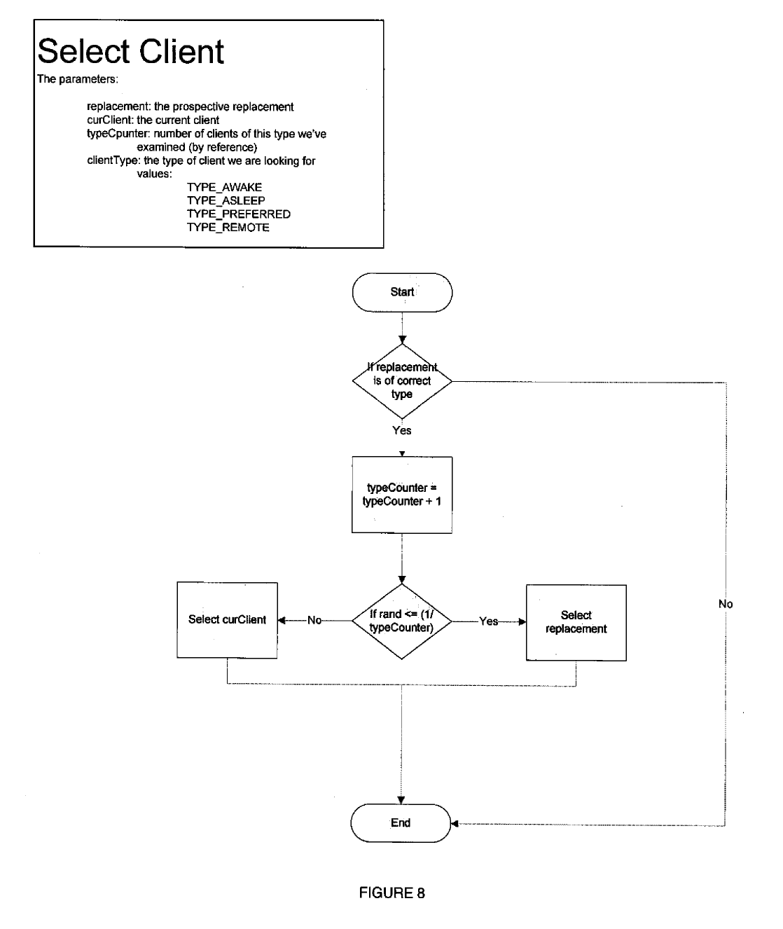

FIG. 8 is a flow chart showing a select client process. The select client process may look at a current client that the system is considering, and may determine whether it is the correct type for the given category that is being considered. For example, if the system is determining whether a given client is asleep, then the select client process will determine whether the current client is in the asleep category. If so, then the select client process will add one to the counter keeping track of how many asleep clients there are. The select client process may also undergo a step to determine whether the current client being considered should replace the current selected asleep client. The step to determine whether to replace the current selected asleep client does not need to be random or may include an element of randomness. For instance, the system may determine whether a random number between 0 and 1 is less than or equal to one over the number of asleep clients. If the random number is less than or equal, then the current client being considered may replace the current selected asleep client, otherwise, the current selected asleep client may remain.

If the current client being considered did not belong to the category being considered—i.e. if the current client was an awake client when the select client process is determining whether the client is an asleep client, then the process may end without any action being taken.

The invention is not limited to the previously described implementation. In alternate embodiments of the invention, the preference categories and order may not exist, or may be altered. Additionally, the method for determining preference categories may be different.

Another aspect of the invention may determine an order of preference for a client computer to serve as a proxy when connected or connecting to a broadcast domain. The system may determine where the newly connected client falls in the preference order for proxies, if one exists. If the client is a more highly preferred proxy from an existing proxy, the WOW system may replace a less desirable proxy with the client.

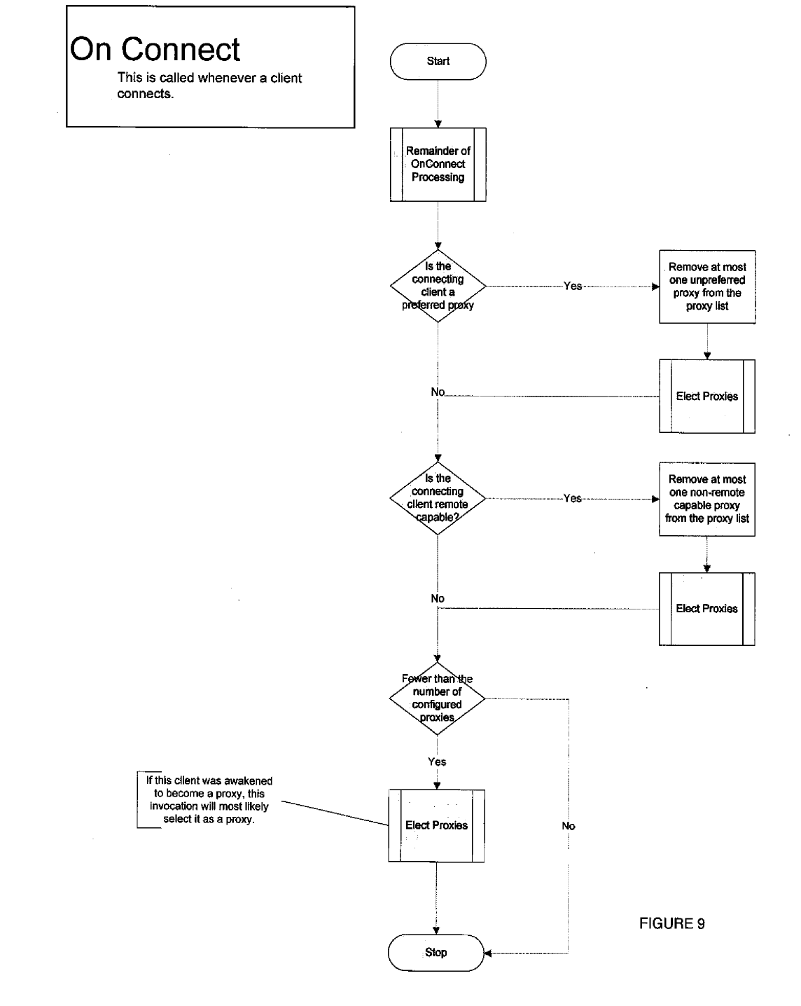

As one example of this aspect, FIG. 9 is a flow chart showing an on connect process that may be called whenever a client connects. Whenever a client may connect, the on connect process may perform a remainder of on connect processing. The system may determine where the connecting client falls in the preference order for proxies. In a preferable embodiment of the invention, the system may determine whether the connecting client is a preferred proxy. If the connecting client is a preferred proxy, it may remove an unpreferred proxy from the proxy list. It may then elect a proxy. The proxy election may follow a proxy election preference order as described previously. If the connecting system is not a preferred proxy, the system may determine whether the connecting client is a remote control capable client. If the connecting client is remote control capable, then the system may remove a non-remote capable proxy from the proxy list. It may then elect a proxy. The system may determine whether there are fewer than the number of configured proxies. If so, the system may elect a proxy.

If the connecting client may have been awakened to become a proxy, the system's election of a proxy will most likely result in the connecting client being selected as a proxy. When a client connects and is higher in the proxy preference order than an existing proxy, it may replace the lower preference proxy with the higher preference proxy.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for remotely waking a computer from a reduced power state to a higher power state comprising:
selecting a plurality of redundant proxies in a broadcast domain capable of receiving a command and broadcasting a wake-up packet to at least one computer within the broadcast domain;
determining whether a minimum number of proxies are operational; and
remotely selecting a new proxy if a minimum number of proxies are not operational.

2. The method according to claim 1 wherein remotely selecting a new proxy follows a preference order wherein the new proxy is a preferred proxy, the new proxy is a remote control capable proxy, the new proxy is not in a reduced power state, and the new proxy is in a reduced power state.

3. The method according to claim 2 further comprising:
determining whether the new proxy is in a reduced power state; and
sending a wake-up packet to the new proxy if the new proxy is in a reduced power state.

4. The method according to claim 1 further comprising determining whether a computer is in the broadcast domain.

5. The method according to claim 4 wherein determining whether a computer is in a broadcast domain includes determining whether the computer has the same IP network number another computer in the broadcast domain.

6. The method according to claim 4 wherein determining whether a computer is in a broadcast domain includes determining whether the computer can hear a user datagram protocol broadcast on a specified port.

7. The method according to claim 1 further comprising:
determining whether a computer is operational in a broadcast domain if no proxies are operational; and
remotely selecting a new proxy from an operational computer in the broadcast domain.

8. The method according to claim 1 further comprising:
determining whether a computer becomes operational in a broadcast domain; and
replacing a lower preference proxy with a higher preference proxy if an operational computer in the broadcast domain is of a higher preference order.

9. A method for remotely waking a computer from a reduced power state to a higher power state comprising:
selecting a plurality of redundant proxies in a broadcast domain capable of receiving a command and sending a wake-up packet to at least one computer within the broadcast domain;
sending a command to at least one proxy, wherein the proxy sends a wake-up packet to at least one computer within the broadcast domain.

10. A system for remotely waking a computer from a reduced power state to a higher power state comprising:
a server;
one or more broadcast domains having at least two computers; and
plurality of redundant proxies in a broadcast domain wherein at least one proxy receives a command from the server and broadcasts a wake-up packet to at least one computer within the broadcast domain.

11. The system for remotely waking a computer of claim 10 wherein the server is capable of determining whether a computer is in the broadcast domain.

12. The system for remotely waking a computer of claim 10 wherein the server is capable of selecting a proxy from the broadcast domain capable of receiving a command from the server and broadcasting a wake-up packet to at least one computer within the broadcast domain.

13. A system of monitoring the status of a proxy within a broadcast domain comprising:
a proxy verification arrangement for use in determining whether a minimum number of proxies greater than one are operational in a broadcast domain; and
a server capable of remotely selecting a new proxy if the minimum number of proxies are not operational in the broadcast domain.

14. The system for monitoring the status of a proxy of claim 13 wherein the server selects a new proxy by following a preference order wherein the new proxy is a preferred proxy, the new proxy is a remote control capable proxy, the new proxy is not in a reduced power state, and the new proxy is in a reduced power state.

15. The system for monitoring the status of a proxy of claim 14 further comprising:
a proxy verification arrangement for use in determining whether the new proxy is in a reduced power state; and
a proxy capable of sending a wake-up packet to the new proxy if the new proxy is in a reduced power state.

16. The system of monitoring the status of a proxy of claim 13 further comprising:
a proxy listening arrangement for use in determining whether a computer is operational in a broadcast domain if no proxies are operational, wherein the server remotely selects a new proxy from an operational computer in the broadcast domain.

17. The method according to claim 13 further comprising:
a network listening arrangement for use in determining whether a computer becomes operational in a broadcast domain; wherein the server replaces a lower preference proxy with a higher preference proxy if an operational computer in the broadcast domain is of a higher preference order.
